(19) United States
(12) Patent Application Publication
(10) Pub. No.: US 2025/0162406 A1
(43) Pub. Date: May 22, 2025

(54) SUSPENDED ENERGY STORAGE UNIT WITH CUBOID PRESSURE VESSELS

(71) Applicant: Volvo Truck Corporation, Göteborg (SE)

(72) Inventors: Sondre LANDVIK, Göteborg (SE); Sigurd SONDEREGGER, Askim (SE)

(21) Appl. No.: 18/841,137

(22) PCT Filed: Apr. 7, 2022
(86) PCT No.: PCT/IB2022/053278

§ 371 Date: Aug. 23, 2024

(51) Int. Cl. B60K 15/07; B60K 1/04; B60K 15/03; B60K 15/063

(52) U.S. Cl. CPC B60K 15/07; B60K 2001/0438; B60K 2015/03151; B60K 2015/03315; B60K 2015/0634

(57) ABSTRACT

A drive system for a vehicle includes a frame, an electric motor, and an energy storage unit suspended from the frame of the vehicle. The energy storage unit includes at least two energy modules including a first energy module having a first cuboid fuel tank and a first cuboid energy storage device including at least one battery. The at least two energy modules further include a second energy module having a second cuboid fuel tank. The at least two energy modules are connected to each other such that the first cuboid fuel tank and the second cuboid fuel tank are connected to opposite sides of the first cuboid energy storage device.

### FIELD

Embodiments relate to energy storage units, and more particularly to a suspended energy storage unit with cuboid pressure vessels for gaseous or liquid fuel, and related systems and devices.

### BACKGROUND

As electric vehicle adoption continues to increase, efficient energy storage becomes increasingly valuable. For example, on fuel-cell electric vehicles (FCEVs), there is a need for storing energy in both batteries and onboard hydrogen fuel tanks. Traditional pressure vessels for gases are commonly cylindrical, which results in underutilization of the volume required to house these vessels in conventional vehicle designs. There is also a need to ensure that energy storage devices and systems are adequately protected from collision and intrusion, which can result in catastrophic failure and thermal events. There is also a need to ensure that the energy storage devices and systems are isolated from the structural movement of the vehicle frame, which may produce an undesirable loads into the components with respect to the vehicle frame and the energy storage devices and systems.

### SUMMARY

According to some embodiments, a drive system for a vehicle includes a frame, an electric motor, and an energy storage unit suspended from the frame of the vehicle. The energy storage unit includes at least two energy modules including a first energy module having a first cuboid fuel tank and a first cuboid energy storage device including at least one battery. The at least two energy modules further include a second energy module having a second cuboid fuel tank. The at least two energy modules are connected to each other such that the first cuboid fuel tank and the second cuboid fuel tank are connected to opposite sides of the first cuboid energy storage device.

According to some embodiments, a method of installing an energy storage unit in an electric vehicle includes connecting at least two cuboid fuel tanks to opposite sides of at least one cuboid energy storage device to form the energy storage unit. The method further includes suspending the energy storage unit from a frame of the electric vehicle.

According to some embodiments, an energy storage unit suspended from a frame of a vehicle includes at least one cuboid energy storage device including at least one battery, and at least two cuboid hydrogen tanks connected to opposite sides of the at least one cuboid energy storage device.

### ASPECTS

According to an aspect, a drive system for a vehicle includes a frame, an electric motor, and an energy storage unit suspended from the frame of the vehicle. The energy storage unit includes at least two energy modules including a first energy module having a first cuboid fuel tank and a first cuboid energy storage device including at least one battery. The at least two energy modules further include a second energy module having a second cuboid fuel tank. The at least two energy modules are connected to each other such that the first cuboid fuel tank and the second cuboid fuel tank are connected to opposite sides of the first cuboid energy storage device.

According to another aspect, the frame includes a wheelbase area between a first axle and a second axle, wherein the energy storage unit is suspended from the wheelbase area.

According to another aspect, the system further includes a plurality of bushings between the energy storage unit and the frame to mechanically isolate the energy storage unit from the frame.

According to another aspect, the system further includes a rod connected to the first energy module and the second energy module to rigidly connect the first energy module and the second energy module together.

According to another aspect, the second energy module includes a second cuboid energy storage device including a battery. The first cuboid energy storage device and the second cuboid energy storage device are connected to each other between the first cuboid fuel tank and the second cuboid fuel.

According to another aspect, the first cuboid fuel tank and the second cuboid fuel tank are hydrogen gas tanks for storing hydrogen gas fuel.

According to another aspect, the first cuboid fuel tank and the second cuboid fuel tank are natural gas tanks for storing natural gas primarily comprising at least one of methane and ethane.

According to another aspect, the first cuboid fuel tank and the second cuboid fuel tank are petroleum gas tanks for storing liquid petroleum gas primarily comprising at least one of propane and butane.

According to another aspect, the first cuboid fuel tank and the second cuboid fuel tank store liquified gaseous fuel at a working pressure of between 5 bar and 450 bar.

According to another aspect, a method of installing an energy storage unit in an electric vehicle includes connecting at least two cuboid fuel tanks to opposite sides of at least one cuboid energy storage device to form the energy storage unit. The method further includes suspending the energy storage unit from a frame of the electric vehicle.

According to another aspect, the method further includes electrically connecting the energy storage unit to an electric motor of the vehicle.

According to another aspect, suspending the energy storage unit from the frame includes mounting a plurality of bushings to the frame, and connecting the energy storage unit to the frame to compress the bushings between the energy module and the frame.

According to another aspect, the method further includes connecting the at least two cuboid fuel tanks together with a rod.

According to another aspect, connecting the at least two cuboid fuel tanks together includes torquing the rod to rigidly join the at least two cuboid fuel tanks together on opposite sides of the at least one cuboid energy storage device.

According to another aspect, the method further includes coupling a first cuboid fuel tank of the at least two cuboid fuel tanks to a first side of a first cuboid energy storage device of the at least one cuboid energy storage device. The method further includes coupling a second cuboid fuel tank of the at least two cuboid fuel tanks to a second side of the first cuboid energy storage device.

According to another aspect, the method further includes coupling a first cuboid fuel tank of the at least two cuboid fuel tanks to a first side of a first cuboid energy storage device of the at least one cuboid energy storage device. The method further includes coupling a second cuboid fuel tank of the at least two cuboid fuel tanks to a second cuboid energy storage device of the at least one cuboid energy storage device.

According to another aspect, the method further includes coupling the first cuboid energy storage device to the second cuboid energy storage device to position the first cuboid fuel tank and the second cuboid fuel tank on opposite sides of the at least one energy storage device.

According to another aspect, suspending the energy storage unit from the frame further includes suspending the energy module from a wheelbase area of the electric vehicle between a first axle and a second axle of the electric vehicle.

According to another aspect, an energy storage unit suspended from a frame of a vehicle includes at least one cuboid energy storage device including at least one battery, and at least two cuboid hydrogen tanks connected to opposite sides of the at least one cuboid energy storage device.

According to another aspect, the energy storage unit further includes a plurality of bushings to isolate the at least two cuboid hydrogen tanks from the frame.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a diagram of a battery electric vehicle, according to some embodiments;

FIGS. 2A-2B are diagrams illustrating mounting a pair of energy modules having cuboid energy storage devices to a frame of the vehicle of FIG. 1, according to some embodiments;

FIG. 3 is a diagram illustrating an energy module, according to some embodiments;

FIGS. 4A-4B are diagrams illustrating mounting an energy storage unit including a pair of energy modules of FIG. 3 to a frame of the vehicle of FIG. 1, according to some embodiments;

FIG. 5 is diagram illustrating a detailed view of mounting a pair of energy modules to a frame of a vehicle, according to some embodiments;

FIG. 6 is a diagram illustrating mounting an energy storage unit to a frame of a vehicle, according to some alternate embodiments; and

FIG. 7 is a flowchart of operations for mounting an energy storage unit to a frame of a vehicle, according to some embodiments.

### DETAILED DESCRIPTION OF EMBODIMENTS

Embodiments relate to energy storage units, and more particularly to a suspended energy storage unit with cuboid pressure vessels for gaseous or liquid fuel, and related systems and devices.

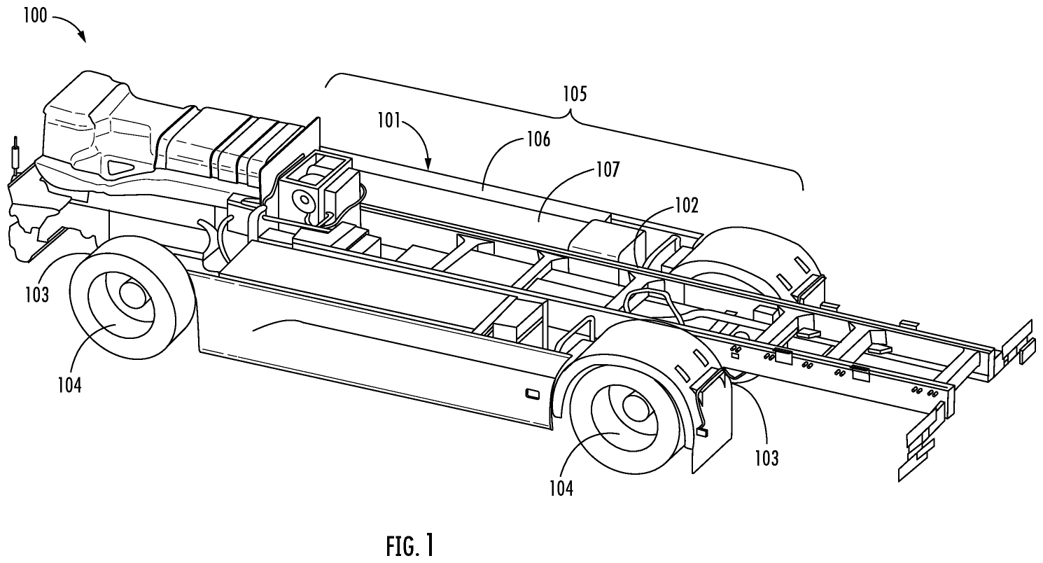

In this regard, FIG. 1 illustrates a hybrid drive system 101 for a vehicle 100, according to some embodiments. The vehicle 100 includes a frame 102 and one or more electric motors 103. In this example, electric motors 103 are provided at each of a plurality of axles 104 defining a wheelbase area 105 of the frame 102.

In this example, an energy storage unit 106 is suspended from the wheelbase area 105 between the two axles 104. The energy storage unit 106 includes one or more energy modules 107. It should be understood, however, that many vehicles may have additional axles, such as a semi-trailer truck having a front axle and multiple rear axles, and that the energy storage unit 106 may be suspended between the front axle and a first rear axle in some embodiments, or in other configurations, as desired.

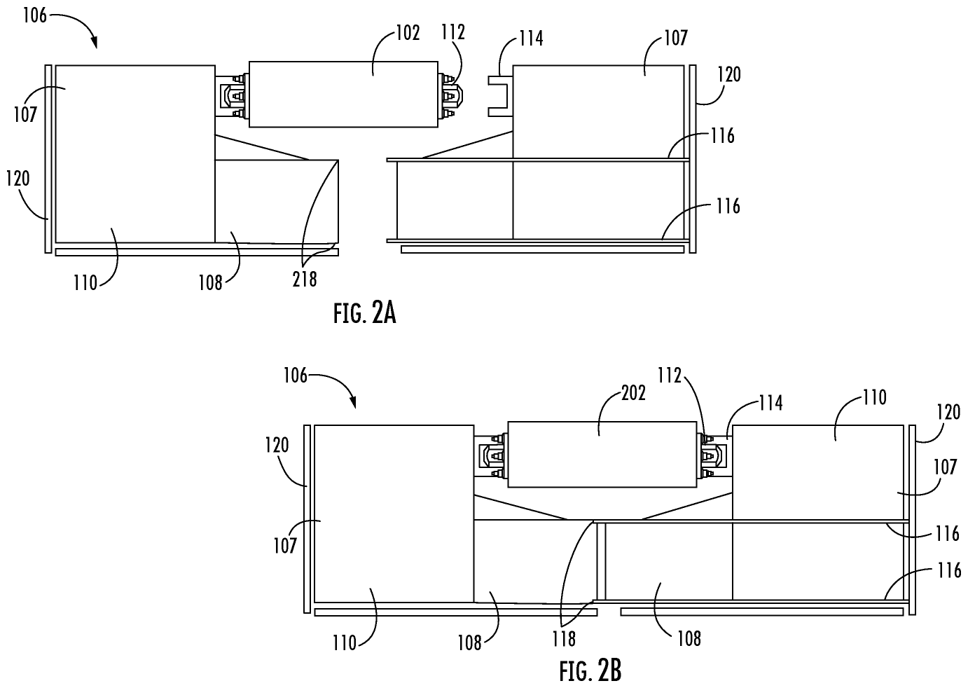

FIGS. 2A and 2B illustrate mounting a pair of energy modules 107 to the frame 102 to suspend the energy storage unit 106 from the frame 102. In this example, each energy module includes a cuboid energy storage device 108, also be referred to as an energy storage system (ESS), which includes at least one battery. Each energy module also includes a cuboid fuel tank 110. As shown in FIG. 2B, the energy modules 107 are connected to each other to form the energy storage unit 106, with the cuboid fuel tanks 110 connected to opposite sides of the cuboid energy storage devices 108.

In this example, male brackets 112 are coupled on opposite sides of the frame 102, and matingly engage with respective female brackets 114 coupled to the energy storage devices 108. In this example, the male brackets 112 include bushings, such as vulcanized rubber, for engaging the female brackets 114 to mechanically isolate the energy storage unit 106 from the frame 102, e.g., from frame torsion and vibrations. In some examples, the bushings may be separate components mounted to the frame 102 between the male brackets 112 and female brackets 114 before coupling the male brackets 112 and female brackets 114 together.

In this example, a plurality of rods 116 rigidly connect the energy modules 107 to each other. In this example, each rod 116 passes through an energy module 107 and is threaded to securely engage a complementary threaded member 118, e.g., threaded nut coupled to an opposite energy module 107.

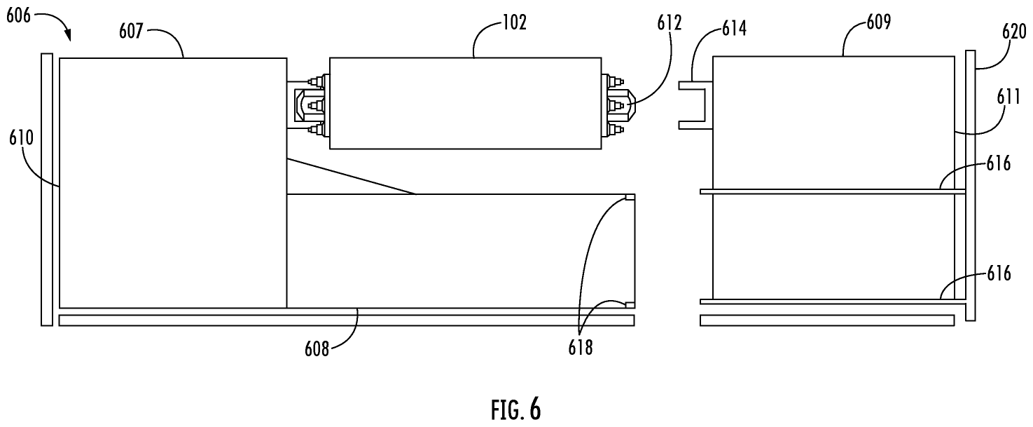

In this example, both energy modules 107 include a respective cuboid energy storage device 108, including at least one battery, with the two cuboid energy storage devices 108 connected together by the connection of the two energy modules 107, with the two energy storage devices connected to each other between the respective cuboid fuel tanks 110. It should be understood, however, that other configurations may be used, such as the configuration of FIG. 6, described in detail below, for example.

The energy storage unit 106 may further include a shield 120 for protecting the components of the energy storage unit 106 from external collision. In this example, the shield 120 includes a plurality of rigid plates, but it should be understood that other arrangements, such as a housing more fully enclosing the energy storage unit 106, may be used.

In some embodiments, the cuboid fuel tanks 110 are hydrogen gas tanks for storing hydrogen gas fuel. Alternatively, or in addition, the cuboid fuel tanks 110 may be natural gas tanks for storing natural gas primarily such as methane and/or ethane for example, and/or petroleum gas tanks for storing liquid petroleum gas such as propane and/or butane, for example. In some embodiments, the cuboid fuel tanks 110 store liquified gaseous fuel at a working pressure of between 5 bar and 450 bar, and up to 700 bar or higher. For example, hydrogen (H2) fuel may be normally stored at a working pressure of between 5 bar and 450 bar. Compressed H2 is often stored at a working pressure of between 350 bar and 700 bar, cryo-compressed H2 is often stored at a working pressure of about 400 bar, and subcooled liquid H2 is often stored at a working pressure of about 20 bar.

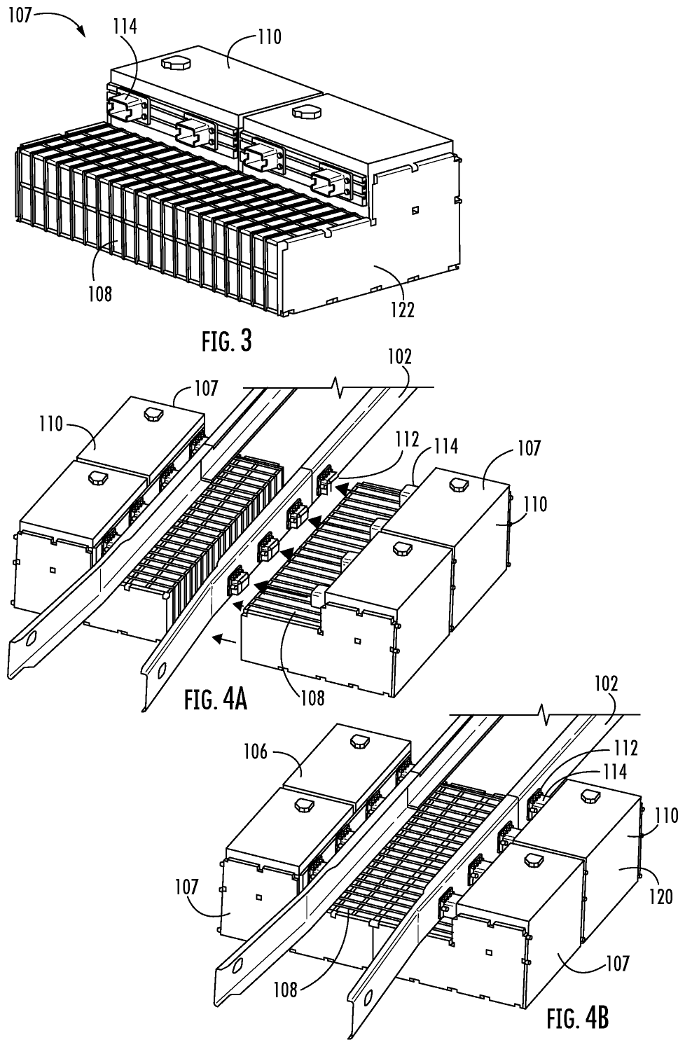

FIG. 3 is a diagram illustrating an isometric view of an energy module 107, according to some embodiments. The energy storage device 108 may include one or more batteries or battery, and the cuboid fuel tank may include a plurality of individual tanks, with the batteries and/or tanks arranged to maximize volume utilization of the energy storage device 108 and/or fuel storage tank 110, and to minimize the amount of unused space in the total volume of the energy module 107. A plurality of female brackets 114 are coupled to the energy module 107 and longitudinally spaced to securely support and suspend the energy module 107.

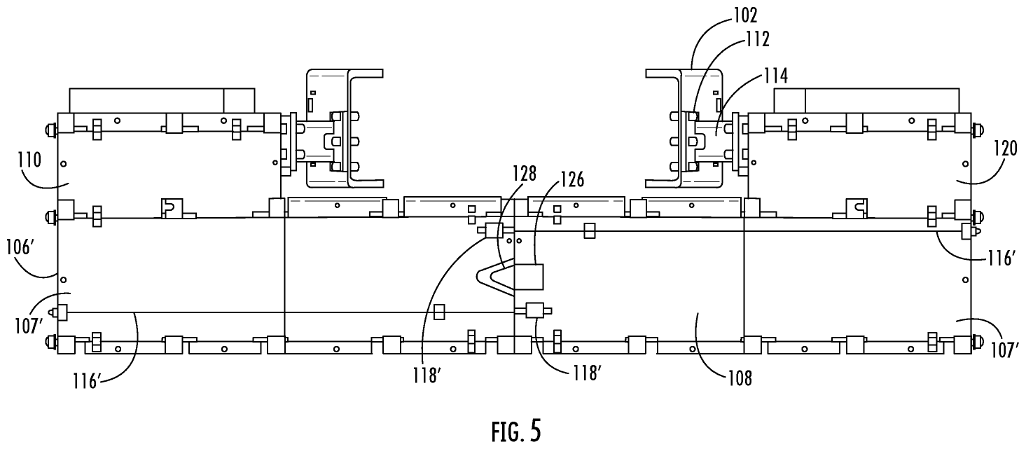

In this regard, referring now to FIGS. 4A and 4B, a diagram illustrating assembly of the energy storage unit 106 and suspension of the energy storage unit 106 from the vehicle frame 102. As shown in FIG. 5, complementary energy modules 107 are mounted to opposite sides of the frame, with each female bracket 114 of the energy modules 107 engaging a complementary male bracket 112 connected to the frame 102. In this example, mounting the energy modules 107 causes bushings associated with the male brackets 112 to be compressed, so that the bushings provide additional support for the energy storage unit 106 while also mechanically isolating the energy storage unit 106 and frame 102 from vibrations and/or mechanical stresses.

As discussed above, the energy modules 107 may be secured to each other by a plurality of rods extending through one energy module 107 and engaging with threaded members of the opposite energy module 107, but it should be understood that other arrangements may be used. In this regard, FIG. 5 is diagram illustrating a detailed view of mounting a pair of energy modules 107′ to the vehicle frame 102, according to an alternative embodiment. In this example, rods 116′ extend through both energy modules 107′ to connect with respective threaded members 118′ on both energy modules 107′, thereby connecting the energy modules 107′ together more securely to form the energy storage unit 106′.

In this example, the energy modules 107′ further include a guiding protrusion 126 on one energy module 107′ and a complementary guiding recess 128 on the opposite energy module 107′. When the energy modules 107′ are mounted to the frame 102, the guiding protrusion 126 matingly engages with the guiding recess 128 to guide and align the energy modules 107′ with respect to each other. In particular, the alignment of the guiding protrusion 126 and the guiding recess 128 aids in aligning the rods 116′ with the respective threaded member 118′ so that the rods 116′ can be quickly and reliably connected with the threaded members 118′ when mounting the energy storage unit 106′ to the frame 102.

Referring now to FIG. 6, mounting an energy storage unit 606 to a vehicle frame 102 according to an alternative embodiment is illustrated. In this example, a first energy module 607 includes an energy storage device 608 and a cuboid fuel tank 610. A second energy module 609 includes another cuboid fuel tank 611. In this example, a plurality of rods 616 extend through the second energy module 609 to engage with threaded members 618 coupled to the energy storage device 608 of the first energy module 607.

Female brackets 614 of the energy modules 607, 609 engage with complementary male brackets 612 connected to the vehicle frame 102, with compressed bushings disposed therebetween, to isolate and protect the frame 102 and energy storage unit 606 from vibration and mechanical stresses.

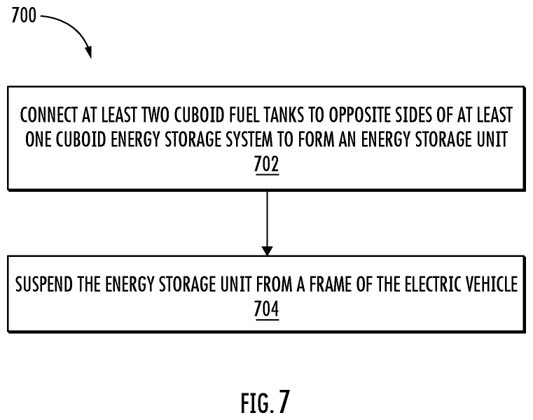

FIG. 7 is a flowchart of operations 700 for mounting an energy storage unit to a frame of a vehicle, according to some embodiments. The operations 700 includes connecting at least two cuboid fuel tanks to opposite sides of at least one cuboid energy storage device to form the energy storage unit (Block 702). The cuboid fuel tanks may include the cuboid fuel tanks 110, 610, 611, discussed above with respect FIGS. 2A-6. The cuboid energy storage device may include the cuboid energy storage devices 108, 608, discussed above with respect FIGS. 2A-6.

The operations 700 further include suspending the energy storage unit from a frame of the electric vehicle (Block 704). Suspending the energy storage unit may include, for example, providing a plurality of bushings mounted to the frame, and connecting the energy storage unit to the frame to compress the bushings between the energy storage unit and the frame. This may be achieved, for example, using the embodiments of FIGS. 2A-6 above, such as by employing the male brackets 112, 612 and/or female brackets 114, 614 to secure the energy storage unit 106, 106′, 606 to the vehicle frame 102. Suspending the energy storage unit from the frame further may further include suspending the energy storage unit from a wheelbase area of the electric vehicle between a first axle and a second axle of the electric vehicle, e.g., a front axle and a rear axle of a semi-trailer truck.

The operations 700 may further include electrically connecting the energy storage unit to an electric motor of the electric vehicle. For example, the energy storage unit 106 of FIG. 1 may be electrically connected to the electric motor 103 to power the motor 103.

Connecting the at least two cuboid fuel tanks to opposite sides of the at least on cuboid energy storage device may further include connecting the at least two cuboid fuel tanks together with a rod, such as with the rod 116, 116′, 616 of FIGS. 2A-6 above. Connecting the at least two cuboid fuel tanks together may include torquing the rod to rigidly join the at least two cuboid fuel tanks together on opposite sides of the at least one cuboid energy storage device.

In some examples, a first cuboid fuel tank is connected to a first side of a first cuboid energy storage device of the at least one cuboid energy storage device, and a second cuboid fuel tank is connected to a second side of the first cuboid energy storage device. In some other examples, a first cuboid fuel tank is coupled to a first side of a first cuboid energy storage device and a second a second cuboid fuel tank is coupled to a second cuboid energy storage device. In this example, the first cuboid energy storage device is coupled to the second cuboid energy storage device to position the first cuboid fuel tank and the second cuboid fuel tank on opposite sides of the energy storage device.

These and other embodiments address the technical problem of efficiently providing energy and fuel storage for an electric vehicle in a safe and space-efficient manner. Unlike conventional cylindrical pressure vessels for fuel, the cuboid energy storage device and fuel tanks allow for more efficient packaging that maximizes available volume for fuel and energy storage. Embodiments of the disclosure also provide collision safety by centrally positioning the energy storage device, e.g., batteries, to protect the energy storage device form side collision and intrusion, which can result in catastrophic failure and thermal events. Meanwhile, the more deformable and expandable fuel tanks, which can withstand larger deformations, may be positioned on the outer sides of the energy storage unit, with an outer housing, e.g., crash shield, protecting the fuel tanks from collision.

Another advantage of positioning the fuel tanks on the outer sides of the frame is that the outside frame volume is larger and allows for higher fuel volumes, which in turn extends the driving range of the vehicle. The batteries, which are power-optimized and intended to take transient loads like braking and accelerations, can be positioned in the comparatively smaller volume toward the center of the frame.

Embodiments also provide a modular and interchangeable mounting and installation process for different types of vehicles, such as battery-powered electric vehicles (BEVs), fuel cell electric vehicles (FCEV), hybrid electric vehicle (HEV), plug-in hybrid electric vehicle (PHEV), and others. These embodiments thereby reduce the number and type of installation components, tools, and processes for producing and mounting different types of vehicles, which in turn reduces costs allows for increased production volume of individual interchangeable components.

Another technical benefit of certain embodiments is that the energy storage units can be mounted to conventional vehicle frame rails without significantly increasing the chassis stiffness or restraining vehicle twisting. Mounting the tanks with bushings isolates the tanks from frame motion and avoid unnecessary stresses in the tanks and brackets. Larger masses can also act like mass dampers and result in lower accelerations on the installed components. In addition, the bushing inhibit the transfer of twisting stresses from the frame to the energy storage unit, thereby preventing wear and damage to the energy storage unit as well.

When an element is referred to as being “connected”, “coupled”, “responsive”, “mounted”, or variants thereof to another element, it can be directly connected, coupled, responsive, or mounted to the other element or intervening elements may be present. In contrast, when an element is referred to as being “directly connected”, “directly coupled”, “directly responsive”, “directly mounted” or variants thereof to another element, there are no intervening elements present. Like numbers refer to like elements throughout. As used herein, the singular forms “a”, “an” and “the” are intended to include the plural forms as well, unless the context clearly indicates otherwise. Well-known functions or constructions may not be described in detail for brevity and/or clarity. The term “and/or” and its abbreviation “/” include any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but do not preclude the presence or addition of one or more other features, integers, elements, steps, components, functions or groups thereof. Furthermore, as used herein, the common abbreviation “e.g.,”, which derives from the Latin phrase “exempli gratia,” may be used to introduce or specify a general example or examples of a previously mentioned item, and is not intended to be limiting of such item. The common abbreviation “i.e.,”, which derives from the Latin phrase “id est,” may be used to specify a particular item from a more general recitation.

Persons skilled in the art will recognize that certain elements of the above-described embodiments may variously be combined or eliminated to create further embodiments, and such further embodiments fall within the scope and teachings of inventive concepts. It will also be apparent to those of ordinary skill in the art that the above-described embodiments may be combined in whole or in part to create additional embodiments within the scope and teachings of inventive concepts. Thus, although specific embodiments of, and examples for, inventive concepts are described herein for illustrative purposes, various equivalent modifications are possible within the scope of inventive concepts, as those skilled in the relevant art will recognize. Accordingly, the scope of inventive concepts is determined from the appended claims and equivalents thereof.

1. A drive system for a vehicle comprising:
a frame;
an electric motor; and
an energy storage unit, the energy storage unit comprising at least two energy modules comprising:
a first energy module comprising a first cuboid fuel tank and a first cuboid energy storage device comprising a battery; and
a second energy module comprising a second cuboid fuel tank,
the at least two energy modules connected to each other such that the first cuboid fuel tank and the second cuboid fuel tank are connected to opposite sides of the first cuboid energy storage device.

2. The system of claim 1, wherein the frame comprises a wheelbase area between a first axle and a second axle, wherein the energy storage unit is suspended from the wheelbase area.

3. The system of claim 1, further comprising a plurality of bushings between the energy storage unit and the frame to mechanically isolate the energy storage unit from the frame.

4. The system of claim 1, further comprising a rod connected to the first energy module and the second energy module to rigidly connect the first energy module and the second energy module together.

5. The system of claim 1, wherein the second energy module comprises a second cuboid energy storage device comprising a battery, wherein the first cuboid energy storage device and the second cuboid energy storage device are connected to each other between the first cuboid fuel tank and the second cuboid fuel tank.

6. The system of claim 1, wherein the first cuboid fuel tank and the second cuboid fuel tank are hydrogen gas tanks for storing hydrogen gas fuel.

7. The system of claim 1, wherein the first cuboid fuel tank and the second cuboid fuel tank are natural gas tanks for storing natural gas primarily comprising at least one of methane and ethane.

8. The system of claim 1, wherein the first cuboid fuel tank and the second cuboid fuel tank are petroleum gas tanks for storing liquid petroleum gas primarily comprising at least one of propane and butane.

9. The system of claim 1, wherein the first cuboid fuel tank and the second cuboid fuel tank store liquified gaseous fuel at a working pressure of between 5 bar and 450 bar.

10. A method of installing an energy storage unit in an electric vehicle, the method comprising:
connecting at least two cuboid fuel tanks to opposite sides of at least one cuboid energy storage device to form the energy storage unit; and
suspending the energy storage unit from a frame of the electric vehicle.

11. The method of claim 10, further comprising electrically connecting the energy storage unit to an electric motor of the electric vehicle.

12. The method of claim 10, wherein suspending the energy storage unit from the frame comprises:
providing a plurality of bushings mounted to the frame; and
connecting the energy storage unit to the frame to compress the bushings between the energy storage unit and the frame.

13. The method of claim 10, wherein connecting the at least two cuboid fuel tanks to opposite sides of the at least one cuboid energy storage device further comprises connecting the at least two cuboid fuel tanks together with a rod.

14. The method of claim 13, wherein connecting the at least two cuboid fuel tanks together comprises torquing the rod to rigidly join the at least two cuboid fuel tanks together on opposite sides of the at least one cuboid energy storage device.

15. The method of claim 10, further comprising:
coupling a first cuboid fuel tank of the at least two cuboid fuel tanks to a first side of a first cuboid energy storage device of the at least one cuboid energy storage device; and
coupling a second cuboid fuel tank of the at least two cuboid fuel tanks to a second side of the first cuboid energy storage device.

16. The method of claim 10, further comprising
coupling a first cuboid fuel tank of the at least two cuboid fuel tanks to a first side of a first cuboid energy storage device of the at least one cuboid energy storage device; and
coupling a second cuboid fuel tank of the at least two cuboid fuel tanks to a second cuboid energy storage device of the at least one cuboid energy storage device.

17. The method of claim 16, further comprising:
coupling the first cuboid energy storage device to the second cuboid energy storage device to position the first cuboid fuel tank and the second cuboid fuel tank on opposite sides of the at least one energy storage device.

18. The method of claim 10, wherein suspending the energy storage unit from the frame further comprises suspending the energy storage unit from a wheelbase area of the electric vehicle between a first axle and a second axle of the electric vehicle.

19. An energy storage unit suspended from a frame of a vehicle, the energy storage unit comprising:
at least one cuboid energy storage device comprising at least one battery; and
at least two cuboid hydrogen tanks to opposite sides of the at least one cuboid energy storage device.

20. The energy storage unit of claim 19, further comprising a plurality of bushings to isolate the at least two cuboid hydrogen tanks from the frame.
